(19) United States
(12) Patent Application Publication
(10) Pub. No.: US 2008/0182715 A1
(43) Pub. Date: Jul. 31, 2008

(54) AUTOMOTIVE-TRANSMISSION CLUTCH-PRESSURE DURATION

(76) Inventor: Mike Dickinson, Hilliard, OH (US)

Correspondence Address: Emerson, Thomson & Bennett, LLC, 777 W. Market Street, Akron, OH, 44303, US

(21) Appl. No.: 11/964,229

(22) Filed: Dec. 26, 2007

Related U.S. Application Data
(60) Provisional application No. 60/877,749, filed on Dec. 29, 2006.

(51) Int. Cl. F16H 59/62

(52) U.S. Cl. 477/97

(57) ABSTRACT

A method for varying automatic-transmission clutch-pressure duration by determining the clutch-pressure duration at least in part as a function of atmospheric pressure to account for a slower hydraulic fill rate associated with automatic-transmission hydraulic clutches at high altitudes.

This application claims priority to U.S. Ser. No. 60/877,749, entitled AUTOMOTIVE-TRANSMISSION CLUTCH-PRESSURE DURATION, filed Dec. 29, 2006, which is incorporated herein by reference.

### I. BACKGROUND OF THE INVENTION

A. Field of Invention

This invention pertains to the art of methods and apparatuses regarding the manufacture and operation of vehicles, and more particularly to methods and apparatuses regarding the control of automatic transmissions at relatively high altitudes.

B. Description of the Related Art

Automatic transmissions include a plurality of gears and associated components that are manipulated to drive an output shaft using different gear ratios. A transmission controller may be used to monitor vehicle operating conditions and driver input to determine whether an up-shift or a down-shift should occur. During an up-shift, an on-coming component gradually engages a next gear as an off-going component gradually disengages the present gear. Typically, the disengagement or release of the off-going component is controlled based on the rate of the on-coming component during the up-shift.

Commonly, automatic transmissions are arranged to shift gears (and thus speed ranges) automatically dependent on various running conditions of the corresponding motor vehicle to achieve desired vehicle running characteristics. It is known in the automotive industry that some of the running conditions may include, for example, engine conditions such as the engine torque, environmental conditions that the vehicle is operating in such as atmospheric pressure, terrain conditions such as slope of the road, and the vehicle's then current speed of travel of the vehicle. It is customary to provide a shift map composed of upshifting and downshifting lines for each speed range. The lines of the shift map may be established in relation to certain variables such as, for example, the vehicle speed, the opening of a throttle valve, and the intake vacuum, which may represent the engine-power-output. The lines of the shift map may also be established to control the automatic transmission's shift of speed ranges according to the shift map dependent on changes of traveling states as indicated on the shift map. One example of such shifting control is disclosed in U.S. Pat. No. 5,827,152 titled CONTROL SYSTEM FOR AUTOMTIC TRANSMISSION FOR VEHICLE, which is hereby incorporated by reference.

As noted above, it is known in the automotive industry that a change in atmospheric pressure resulting from, for example, a corresponding change in altitude affects automotive engine performance. A relatively lower atmospheric pressure generally corresponds to a relatively higher altitude. This lower atmospheric pressure results in the vehicle engine producing a reduced engine torque relative to the engine torque produced at or around sea level. Commonly, during clutch-to-clutch shifting in an automatic transmission at relatively high altitudes (lower atmospheric pressure relative to that at or around sea level), modifying the clutch pressure of an automatic-transmission may aid in creating a smoother shift that is less noticeable to a passenger. This smoother shift results in an improvement in a passenger's riding comfort.

Typically, a computerized pressure control mode determines, among other things, the on-coming clutch pressure, hereafter referred to as the response pressure, in clutch-to-clutch shifting in an automatic transmission. Compared to clutch pressures desirable at or around sea level, clutch pressures at relatively higher altitudes are typically reduced in order to better match the reduced engine torque resulting from the decreased atmospheric pressure.

Many automatic-transmissions work well for their intended purpose though they are known to have disadvantages. One disadvantage relates to the operational side effect of the on-coming clutch filling with hydraulic fluid more slowly when clutch-pressure is reduced. Conventional automatic transmissions, utilizing a reduced clutch pressure at high altitudes, do not allow for this slower hydraulic fill rate and therefore, a passenger will experience “shift-shock” or greater ride discomfort. Additionally, failure to account for a slower hydraulic fill rate may result in the hydraulic clutch “'slipping” prior to becoming fully engaged This slipping may cause increased wear of the hydraulic clutch's frictional element. This increased wear may result in increased maintenance cost and decreased reliability of the automatic transmission. There is therefore a need for methods directed to creating an automatic-transmission control that compensates for the slower hydraulic fill rate occurring at high altitudes.

### II. SUMMARY OF THE INVENTION

According to one embodiment of this invention, a method comprises the steps of determining the atmospheric pressure, adjusting a clutch pressure, and adjusting a clutch pressure duration with respect to the atmospheric pressure. The clutch pressure duration may be determined at least in part as a mathematical function of the atmospheric pressure and a clutch pressure magnitude. Alternatively, the clutch pressure duration may be determined at least in part as a mathematical function of the atmospheric pressure and an engine torque.

According to another embodiment of this invention, a method comprises the steps of providing a vehicle having a first clutch pressure and a first clutch duration at a first atmospheric pressure, moving the vehicle to a second atmospheric pressure, adjusting the first clutch pressure and the first clutch pressure duration with respect to the atmospheric pressure. The additional step of determining the atmospheric pressure may occur prior to the step of adjusting the first clutch pressure. Further, the clutch pressure duration may be determined at least in part as a mathematical function of the atmospheric pressure and a clutch pressure magnitude or at least in part as a mathematical function of the atmospheric pressure and a clutch pressure duration.

According to another embodiment of this invention, a vehicle may comprise an engine, an automatic transmission, and a control unit. The control unit may determine a clutch pressure duration at least in part as a function of an atmospheric pressure. Alternatively, the control unit may determine the clutch pressure duration at least in part as a function of the atmospheric pressure and an engine torque. Additionally, the vehicle may comprise an atmospheric pressure detection device for determining atmospheric pressure.

One advantage of this invention is that the shift-shock experienced by a passenger in an automobile at high altitude is reduced resulting in an improvement in the passenger's ride comfort. By varying the clutch pressure duration of an automatic-transmission clutch-to-clutch shift, the resulting shift feel experienced by a user may improve relative to an automatic-transmission clutch-to-clutch shift system that uses a constant clutch-pressure duration.

Another advantage of this invention is that the frictional element of a hydraulic clutch experiences less wear resulting from slipping when clutch pressure duration is modified at high altitudes. This decrease in wear of the frictional element has the additional advantage of prolonging the life, or period of usability, of the frictional element.

Still other benefits and advantages will become apparent to those skilled in the art to which it pertains upon a reading and understanding of the following detailed specification.

### III. BRIEF DESCRIPTION OF THE DRAWINGS

The invention may take physical form in certain parts and arrangement of parts, embodiments of which will be described in detail in this specification and illustrated in the accompanying drawings which form a part hereof and wherein:

FIG. 1 is a schematic view of an automatic transmission controlled by a shift control method according to one embodiment of the invention.

FIG. 2 graphically illustrates a prior art shift control relationship of normal and high-altitude clutch-pressure requests and their respective response timer.

FIG. 3 graphically illustrates a shift map used for shift control at normal and high altitudes according to one embodiment of the invention.

FIG. 4 is a block diagram of a shift control apparatus in which a shift control method is performed according to one embodiment of the invention.

FIG. 5 graphically illustrates a shift control diagram that may be used for shift control of one embodiment of the invention at both normal atmospheric pressure and at low atmospheric pressure.

FIG. 6 graphically illustrates an upward and downward shift pattern according to one embodiment of the invention.

### IV. DETAILED DESCRIPTION OF THE INVENTION

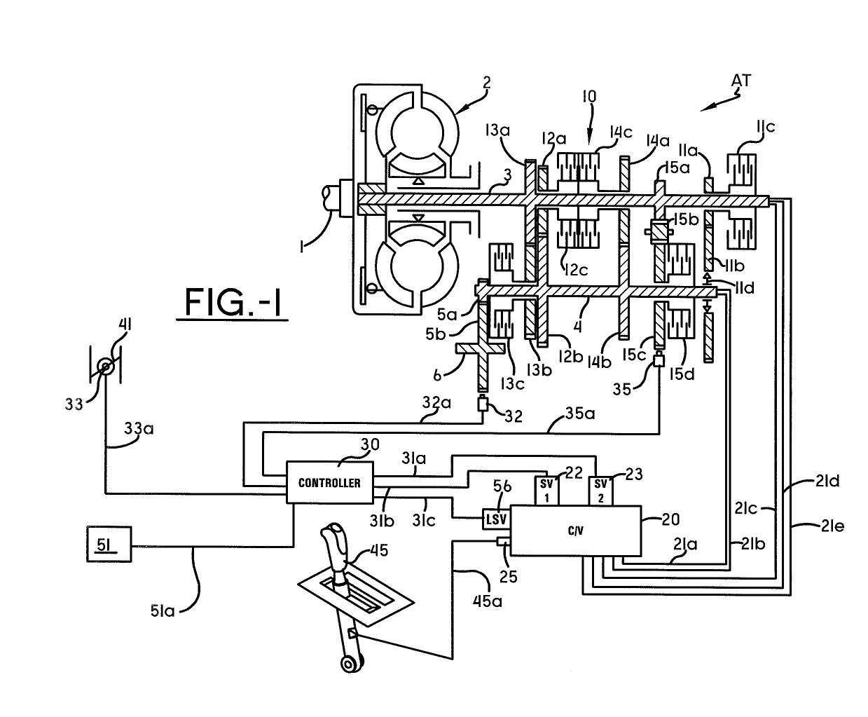

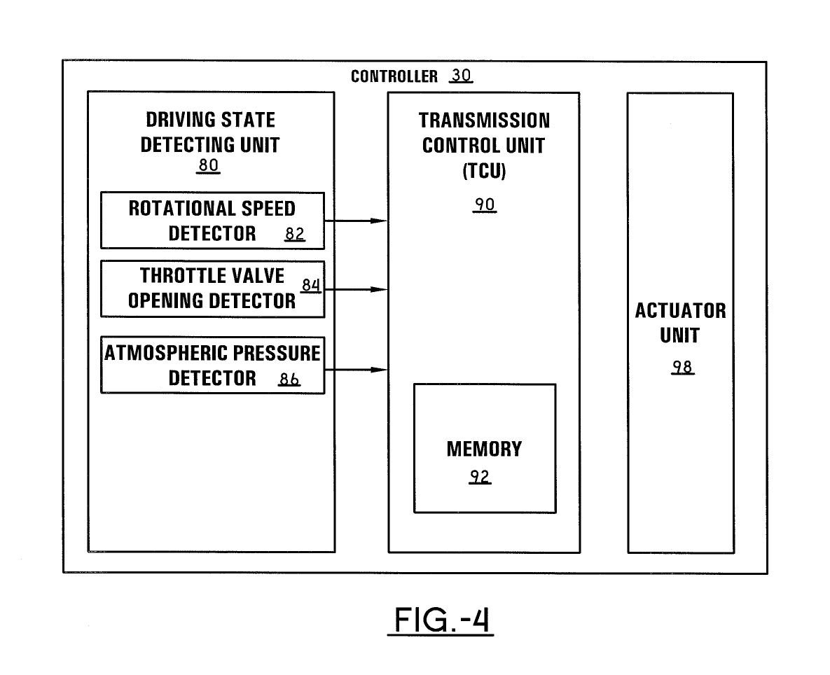

Referring now to the drawings wherein the showings are for purposes of illustrating embodiments of the invention only and not for purposes of limiting the same, a vehicle, not shown, may comprise a transmission system AT shown schematically in FIG. 1. The transmission system AT may have a transmission mechanism 10, a control system 30 (shown in more detail in FIG. 4) and a shift lever 45. The transmission mechanism 10 may comprise a plurality of gear trains for changing the speed of rotation of the engine-power-output transmitted from an engine output shaft 1 through a torque converter 2 and for applying the engine-power-output to an output shaft 6. The control system 30 may include a computer with software. Since, in this case, the type or configuration of the hardware or software and the range of features implemented can take various forms and ranges, virtual circuit blocks that implement those individual functions are used in the following description. The control system 30 may comprise a driving state detection unit 80, a transmission control unit 90, and an actuator unit 98.

With reference now to FIG. 1, according to one embodiment, the engine-power-output from the torque converter 2 may be applied to a transmission input shaft 3, and then may be transmitted, while its rotational speed is being changed, to a countershaft 4 that may extend parallel to the input shaft 3 through a selected one of five gear trains that may be disposed parallel between the input shaft 3 and the countershaft 4. The engine power output may then be applied from the countershaft 4 to the output shaft 6 through output gears 5a, 5b that may be disposed between the countershaft 4 and the output shaft 6.

With continuing reference to FIG. 1, the five gear trains between the input shaft and the countershaft 4 may include a gear train that may be composed of gears 11a, 11b for a first speed range, a gear train composed of gears 12a, 12b for a second speed range, a gear train composed of gears 13a, 13b for a third speed range, a gear train composed of gears 14a, 14b for a fourth speed range, and a gear train composed of gears 15a, 15b, 15c for a reverse speed range. These gear trains may be associated respectively with hydraulically operated clutches 11c, 12c, 13c, 14c, and 15d that may enable the gear trains to transmit the engine-power-output from the input shaft 3 to the countershaft 4. A one-way clutch 11d may be disposed in the gear 11b. By selectively operating the hydraulically operated clutches, one of the five gear trains may be selected for engine power transmission while changing the rotational speed of the transmitted engine power output.

With continuing reference to FIG. 1, the five hydraulically operated clutches 11c, 12c, 13c, 14c, and 15d may be controlled in operation by a hydraulic pressure that may be supplied and discharged through hydraulic pressure lines 21a through 21e from and to a hydraulic pressure control valve assembly 20. The hydraulic pressure control valve assembly 20 may be operated by a manual spool valve 25, that may be coupled by a wire 45a to the shift lever 45 that may be movable by a driver (not shown); two solenoid valves 22, 23; and a linear solenoid valve 56.

With reference now to FIGS. 1, 3-6, the solenoid valves 22, 23 may be selectively actuated and inactivated by operating signals that may be supplied from the control system 30 through signal lines 31a, 31b. The linear solenoid valve 56 may be operated by a signal from the control system 30 via a signal line 31c. The driving state detecting unit 80 may comprise a rotational speed detector 82, a throttle valve opening dector 84, and an atmospheric pressure detector 86. The transmission control unit 90 may be realized as a microprocessor activated by a predetermined program, and may comprise a memory unit 92. Memory unit 92 may comprise be used to store variable values that may be used for speed shifts as well as variable values that may be used for modification of the stored variables, such as clutch-pressure duration, due to the detected driving states.

With continuing reference to FIGS. 1, 3-6, the control system 30, via its corresponding detectors, may be supplied with a rotational speed signal that may be fed via a signal line 35a from a first rotational speed sensor 35 which may detect the rotational speed of an input member of the hydraulically operated clutch 15d based on rotation of the reverse gear 15c, a rotational speed signal that may be fed via a signal line 32a from a second rotational speed sensor 32 which may detect the rotational speed of an output member of the hydraulically operated clutch 13c based on rotation of the output gear 5b, a throttle valve opening signal that may be fed via a signal line 33a from a throttle valve opening sensor 33 that may detect the opening of an engine throttle valve 41, and an atmospheric pressure signal that may be fed via signal line 51a from an atmospheric pressure sensor 51 that may detect the automatic-transmission atmospheric pressure.

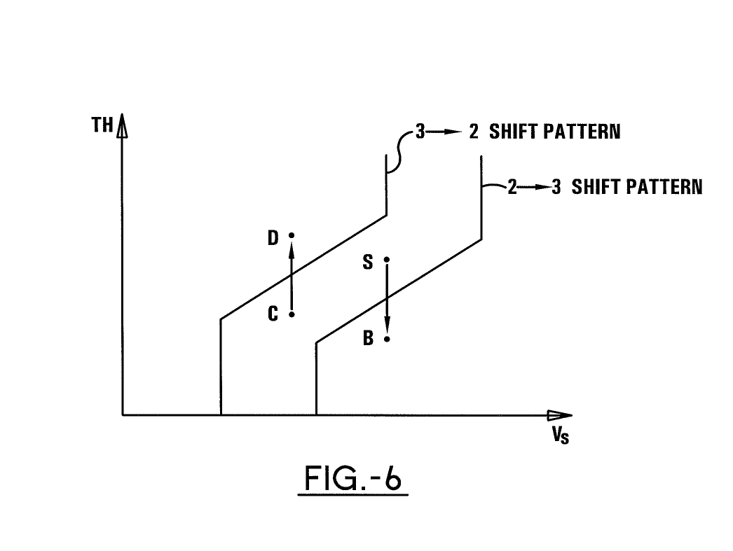

With reference now to FIGS. 4, 6, the transmission control unit 30 may determine a shift-speed under the driving conditions detected by control system 30 and may perform a speed shift to the determined shift speed. Whether a speed shift is necessary may be determined based on a shift-pattern. Each shift-pattern may form a line. The shift-pattern may include an upward shift pattern USP and a downward shift pattern DSP. The upward shift pattern USP may be used for determining that an upward shift is necessary and the downward shift pattern DSP may be used for determining that a downward shift is necessary.

With reference now to FIG. 6, a driving state may be determined by a vehicle speed VS and a throttle valve opening TH. In one embodiment, when the driving state currently corresponds to a point C of FIG. 6, the driving state may change to correspond to a point D of FIG. 6 if the throttle valve opening TH is increased. As the driving state crosses the upward shift pattern USP along line CD, an upward speed-shift may be necessary. When the driving state currently corresponds to a point A of FIG. 6, the driving state may change to correspond to a point B of FIG. 6 if the throttle valve opening TH is decreased As the driving state crosses the downward shift pattern DSP along line AB, a downward speed-shift may be necessary.

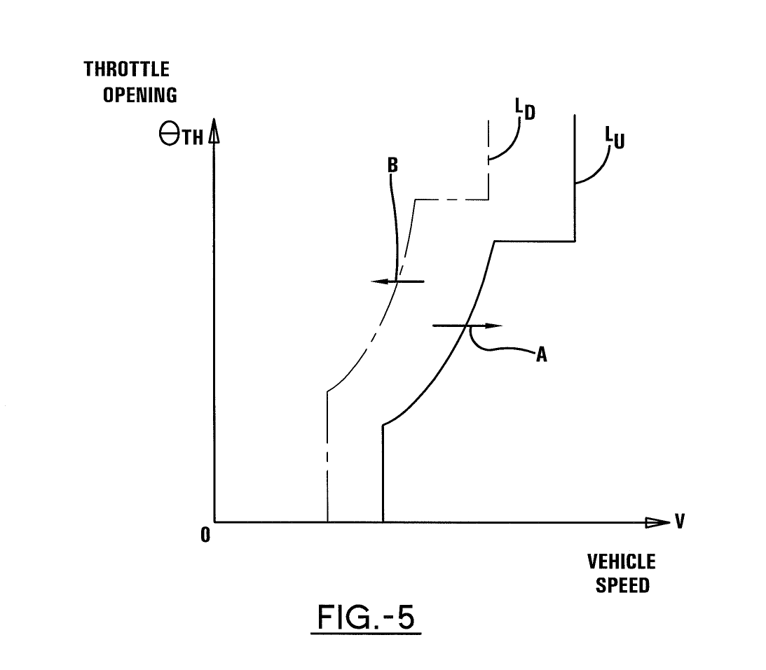

With reference now to FIG. 5, a shift-pattern may be modified when the vehicle is operating at high altitudes. The shift-pattern may be modified in order to compensate for the lower atmospheric pressure that may exist at the higher altitude relative to the atmospheric pressure that may exist at altitudes at or around sea level. Modification factors may be used for modifying an upward shift-pattern relating to when the vehicle is operating at these higher altitudes. Modification factors for determining an upward shift-pattern at high altitudes may include a modified clutch-pressure duration, a modified clutch-pressure magnitude, and an engine-torque-modification-factor. Embodiments are generally provided for automatic-transmission clutch-to-clutch shifting, wherein a variable clutch-pressure duration is calculated at least in part by using a mathematical function of automatic-transmission altitude, clutch-pressure magnitude, automatic-transmission engine torque, or a combination thereof.

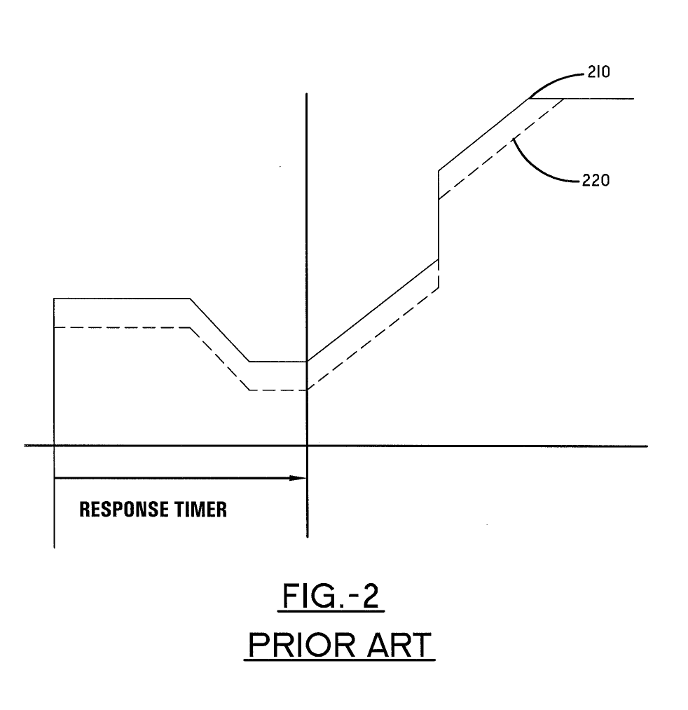

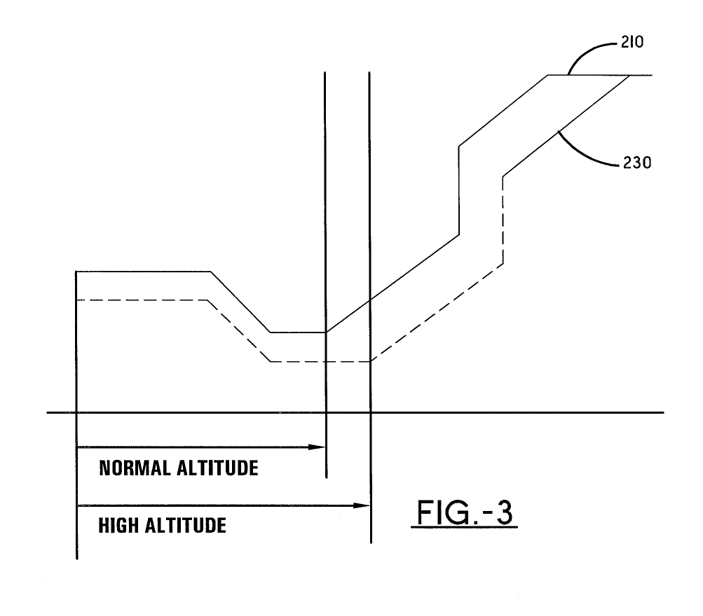

With reference now to FIG. 2, the solid line 210 may denote a shift-pattern for an automatic-transmission at or around sea level according to one embodiment of the invention. A first dotted line 220 may denote a modified shift-pattern at high altitude wherein the clutch-response time has not been modified. With reference now to FIG. 3, the solid line 210 may denote a shift-pattern for an automatic-transmission at or around sea level according to one embodiment of the invention. The solid line 210 may represent the same shift-pattern as shown in FIG. 2. A second dotted line 230 may denote a modified shift-pattern at high altitude wherein clutch-response time has been modified to account for the slower hydraulic fill rate.

With reference now to FIGS. 1, 3-5, the atmospheric pressure sensor 51 may determine the atmospheric pressure at the atitude at which the vehicle (not shown) is driving. The atmospheric pressure sensor 51 may be realized by a sensor disposed outside of the engine 34 for detecting atmospheric pressure. Other known methods for determining atmospheric pressure, either directly or indirectly, chosen with sound engineering judgment may be used. The atmospheric pressure sensor 51 may then output a signal to the atmospheric pressure detector 86. The control system 30 may then determine the vehicle driving state based upon the atmospheric pressure detected by atmospheric pressure sensor 51, the vehicle speed VS, and the throttle valve opening TH. and whether a speed shift to a target shift-speed is necessary. If a speed-shift is determined to be necessary and the control system 30 determines that a low atmospheric pressure exists, clutch-pressure duration may be modified to account for a slower hydraulic fill rate. Embodiments for calculating clutch-pressure duration may be independently based upon clutch-pressure magnitude, automatic-transmission altitude, automatic-transmission engine torque, or any combination of these variables. The clutch-pressure duration may be calculated in real-time by an on-board vehicle computer. Transmission-related computer calculations are common and well known in the art, and any known on-board computer that can perform such calculations may be utilized to carry out calculations used to determine clutch-pressure duration. It is well known that during the operation of an automatic-transmission engine, one or more calculations are performed in real-time in order to facilitate engine operation. Any existing manner for performing a real-time calculation during the operation of an automatic-transmission engine chosen with sound engineering judgment may be used or retrofitted with any of the inventive functions for calculating clutch-pressure duration according to the embodiments provided herein.

Various embodiments have been described, hereinabove. It will be apparent to those skilled in the art that the above methods and apparatuses may incorporate changes and modifications without departing from the general scope of this invention. It is intended to include all such modifications and alterations insofar as they come within the scope of the appended claims or the equivalents thereof.

Having thus described the invention, it is now claimed:

1. A method comprising the steps of:
(a) determining atmospheric pressure;
(b) adjusting a clutch pressure with respect to the atmospheric pressure; and
(c) adjusting a clutch pressure duration with respect to the atmospheric pressure.

2. The method of claim 1, wherein step (c) further comprises the step of:
determining the clutch pressure duration at least in part as a mathematical function of the atmospheric pressure and a clutch pressure magnitude.

3. The method of claim 1, wherein step (c) further comprises the step of:
determining the clutch pressure duration at least in part as a mathematical function of the atmospheric pressure and an engine torque.

4. A method comprising the steps of:
(a) providing a vehicle at a first atmospheric pressure comprising a first clutch pressure and a first clutch duration;
(b) moving the vehicle to a second atmospheric pressure;
(c) adjusting the first clutch pressure with respect to the atmospheric pressure; and
(d) adjusting the first clutch pressure duration with respect to the atmospheric pressure.

5. The method of claim 4, wherein the step after step (b) and prior to step (c) comprises the step of:
determining the atmospheric pressure.

6. The method of claim 4, wherein step (c) further comprises the step of:
determining the clutch pressure duration at least in part as a mathematical function of the atmospheric pressure and a clutch-pressure magnitude.

7. The method of claim 4, wherein step (c) further comprises the step of:
determining the clutch pressure duration at least in part as a mathematical function of the atmospheric pressure and an engine torque.

8. A vehicle comprising:
an engine;
an automatic transmission; and,
a control unit that determines a clutch pressure duration at least in part as a function of an atmospheric pressure.

9. The vehicle of claim 8, wherein the control unit:
determines the clutch pressure duration at least in part as a function of the atmospheric pressure and a clutch pressure magnitude.

10. The vehicle of claim 8, wherein the control unit:
determines the clutch pressure duration at least in part as a function of the atmospheric pressure and an engine torque.

11. The vehicle of claim 8, further comprising:
an atmospheric pressure detection device.
